(19) United States
(12) Patent Application Publication
(10) Pub. No.: US 2018/0231431 A1
(43) Pub. Date: Aug. 16, 2018

(54) SUBSURFACE MONITORING

(71) Applicants: AgraTek, LLC, Cave Creek, AZ (US); The United States of America as represented by the Secretary of Agriculture, Washington, DC (US)

(72) Inventors: Henry Gordon Minns, Cave Creek, AZ (US); Roger Allen Eigenberg, Hastings, NE (US); Bryan Lee Woodbury, Clay Center, NE (US)

(21) Appl. No.: 15/897,289

(22) Filed: Feb. 15, 2018

Related U.S. Application Data
(60) Provisional application No. 62/459,828, filed on Feb. 16, 2017.

(51) Int. Cl. G01M 3/16; G01M 3/00; G01V 3/02

(52) U.S. Cl. CPC G01M 3/16; G01V 3/02; G01M 3/007

(57) ABSTRACT

Subsurface monitoring can include obtaining a first set of subsurface resistivity measurements at a first time using a subsurface monitoring apparatus and obtaining a second set of subsurface resistivity measurements at a second different time using the subsurface monitoring apparatus. The second set of subsurface resistivity measurements can be compared to the first set of subsurface resistivity measurements, for instance at the subsurface monitoring apparatus or another component in a system. A notification can be generated when the second set of subsurface resistivity measurements differs from the first set of subsurface resistivity measurements by a first predetermined threshold. The subsurface monitoring apparatus can include a main controller and a plurality of electrode probes that extend a distance into a ground surface. A remote server can be in communication with the subsurface monitoring apparatus over a network.

### RELATED APPLICATIONS

This application claims the benefit of U.S. Provisional Patent Application No. 62/459,828, filed Feb. 16, 2017, the entire contents of which are incorporated herein by reference.

### GOVERNMENT RIGHTS

This invention was made with government support under Award No. 2016-33610-25562 awarded by the United States Department of Agriculture. The government may have certain rights in the invention.

### TECHNICAL FIELD

This disclosure relates generally to subsurface monitoring. In particular, this disclosure provides examples of apparatuses, systems, methods, and computer-executable instructions for subsurface monitoring in a variety of applications. One exemplary application of such subsurface monitoring disclosed herein for illustrative purposes is subsurface wastewater leaks and, relatedly, detection of groundwater contamination.

### BACKGROUND

A variety of facilities have the potential to cause groundwater contamination. Such facilities include power plants, mining and drilling operations, landfills, feedlots, and municipal infrastructure. These facilities produce and/or transport different forms of waste that include contaminates. Often, this waste is stored on site for a period of time in holding ponds, lagoons, trenches, tanks, or other waste structures embedded in the soil. These storage structures are usually lined with a barrier that is intended to prevent fluid contaminates from migrating into the surrounding soil. However, the barrier can be susceptible to failure, for instance due to wear, rips/tears, or improper installation. When the barrier fails, fluid contaminates can permeate into the surrounding soil and can ultimately become entrained in the groundwater.

In many locations, regulations are in place that prohibit contaminates from leaking into the groundwater. However, current groundwater contamination monitoring can be expensive and time-consuming. Current groundwater contamination monitoring may also be inadequate in discerning which waste storage structure in an area of detected contamination is of serious concern, thereby complicating remedial efforts. In addition, these current groundwater contamination monitoring practices often fail to identify leaks until well after the leak has developed and since advanced into a significant problem. Therefore, in addition to making compliance with regulations resource intensive, current contamination monitoring practices make remediation efforts difficult by failing to identify a leak early on.

### SUMMARY

In general, exemplary embodiments of apparatuses, systems, methods, and computer-executable instructions are disclosed herein for subsurface monitoring. These embodiments can be employed in a variety of useful applications. For instance, these embodiments can be used in detecting groundwater contamination. In this application, these embodiments may be able to quickly detect a waste structure subsurface leak and thereby increase the likelihood that remediation efforts in connection with the waste structure will be effective. Further, in some cases, embodiments of a subsurface monitoring apparatus can be installed at one or more locations adjacent to an existing waste structure, and need not necessarily be installed at the initial creation of the waste structure. Disclosed embodiments can also allow for a determination that a leak, or other subsurface condition, is present and this can allow this determination to be routed through a network to those best able to take action to address the issue. In addition, certain embodiments provide network connectivity to a subsurface monitoring apparatus and a number of local devices at the same site. This network connectivity can allow for collection of data from one or more of these local devices, for instance at remote locations relative to a subsurface monitoring apparatus, and thereby allow for evaluation of subsurface resistance measurement in the context of other non-resistivity measurements from a similar locale, and may thereby increase the accuracy of waste structure related resistance analysis.

While the exemplary application of detecting groundwater contamination, for instance due to a waste structure subsurface leak, is described herein, various other applications of this disclosure are possible. As one example of another application, details of this disclose can be used to track movement of one or more subsurface contaminates. For instance, details of this disclosure can be used to track fertilizer, or other foreign substance, within the subsurface vicinity of a subsurface monitoring apparatus. Sets of subsurface resistivity measurements can be taken at different times, compared, and based on this comparison used to track movement of the fertilizer from the surface to depth(s) at a root location and/or longitudinally along the subsurface to different longitudinally spaced root locations. Such an exemplary application could be useful for optimizing the delivery of fertilizer to desired subsurface roots of crops or other agricultural products.

One embodiment includes a method for subsurface monitoring. This method includes the steps of obtaining a first set of subsurface resistivity measurements during a first time using a subsurface monitoring apparatus and obtaining a second set of subsurface resistivity measurements during a second different time using the subsurface monitoring apparatus. The second set of subsurface resistivity measurements can be compared to the first set of subsurface resistivity measurements. A subsurface condition notification, such as a leak notification, can be generated when the second set of subsurface resistivity measurements differs from the first set of subsurface resistivity measurements by a first predetermined threshold.

Another embodiment includes a non-transitory computer-readable storage article having computer-executable instructions stored thereon. These computer-executable instructions can cause at least one programmable processor to receive a first set of subsurface resistivity measurements taken during a first time using a subsurface monitoring apparatus and to receive a second set of subsurface resistivity measurements taken during a second time using the subsurface monitoring apparatus, the second time being after the first time. These computer-executable instructions can compare the second set of subsurface resistivity measurements to the first set of subsurface resistivity measurements and can output a leak notification, when the second set of subsurface resistivity measurements differs from the first set of subsurface resistivity measurements by a first predetermined threshold.

A further embodiment includes a subsurface monitoring apparatus. The subsurface monitoring apparatus includes a plurality of electrode probes and a main controller. The plurality of electrode probes can be spaced apart from one another and extend a distance into a ground surface. The main controller can be in electrical connection with each of the plurality of electrode probes. The main controller can be configured to execute a first measurement sequence during a first time to obtain a first set of subsurface resistivity measurements that includes individual subsurface resistivity measurements at a number of differing longitudinal and depth locations relative to the ground surface. The main controller can also be configured to execute the first measurement sequence during a second time that is after the first time to obtain a second set of subsurface resistivity measurements that includes individual subsurface resistivity measurement at the number of differing longitudinal and depth locations relative to the ground surface in the first set of subsurface resistivity measurements. In addition, the main controller can be configured to compare the second set of subsurface resistivity measurements to the first set of subsurface resistivity measurements and generate a subsurface condition notification when the second set of subsurface resistivity measurements differs from the first set of subsurface resistivity measurements by a first predetermined threshold.

An additional embodiment includes a subsurface monitoring system. The subsurface monitoring system includes a subsurface monitoring apparatus and a remote server in communication (e.g., two-way) with the subsurface monitoring apparatus over a network. The subsurface monitoring apparatus includes a plurality of electrode probes and a main controller. The plurality of electrode probes are spaced apart from one another and extend a distance into a ground surface. The main controller is in electrical connection with each of the plurality of electrode probes. The main controller is configured to execute a first measurement sequence during a first time to obtain a first set of subsurface resistivity measurements that includes individual subsurface resistivity measurements at a number of differing longitudinal and depth locations relative to the ground surface. And, the main controller is configured to execute the first measurement sequence during a second time that is after the first time to obtain a second set of subsurface resistivity measurements that includes individual subsurface resistivity measurement at the number of differing longitudinal and depth locations relative to the ground surface in the first set of subsurface resistivity measurements. One of the subsurface monitoring apparatus and the remote server includes a non-transitory computer-readable storage article having computer-executable instructions stored thereon to cause at least one programmable processor to: i) compare the second set of subsurface resistivity measurements to the first set of subsurface resistivity measurements, and ii) generate a subsurface condition notification when the second set of subsurface resistivity measurements differs from the first set of subsurface resistivity measurements by a first predetermined threshold.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a schematic, elevational view of an exemplary embodiment of a subsurface monitoring apparatus.

FIG. 2 is an exemplary plot of a set of subsurface resistivity measurements obtained using the subsurface monitoring apparatus of FIG. 1.

FIG. 3 is an exemplary graphical illustration of an analytical output from a comparison between sets of subsurface resistivity measurements indicating detection of a subsurface leak.

FIG. 4 is a schematic diagram of an exemplary embodiment of a subsurface monitoring system, including the subsurface monitoring apparatus shown in FIG. 1.

FIG. 5 is a flow diagram of an exemplary embodiment of a method for subsurface monitoring.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, and/or dimensions are provided for selected elements. Those skilled in the art will recognize that many of the noted examples have a variety of suitable alternatives.

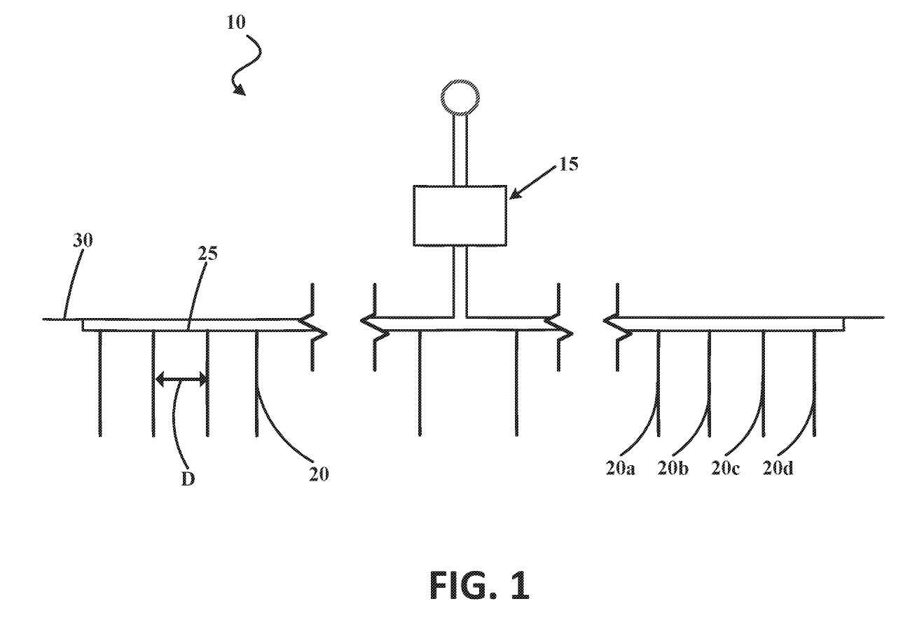

FIG. 1 shows a schematic, elevational view of an exemplary embodiment of a subsurface monitoring apparatus 10. In one exemplary application, the subsurface monitoring apparatus 10 can be located adjacent a holding pond, lagoon, waste trench, or other waste storage structure or facility (e.g., drilling well) of potential concern for groundwater contamination. For instance, in one specific such example the subsurface monitoring apparatus 10 can be spaced from the waste storage structure and at that spaced location extend a length alongside one or more sides of the waste storage structure. In one instance, the subsurface monitoring apparatus 10 may extend a length alongside a first side of the waste storage structure and a length alongside a second different side of the waste storage structure (e.g., adjacent, such as perpendicular, sides of the waste storage structure). Thus, in such examples the subsurface monitoring apparatus 10 may not actually extend into the waste storage structure itself, but instead can be positioned spaced from the waste storage structure and extend alongside a side of the waste storage structure. The subsurface monitoring apparatus 10 may serve in some cases as a permanent installation at such location taking frequent (e.g., daily, hourly, weekly) measurements over a prolonged period of time (e.g., months, years) thereat.

The exemplary subsurface monitoring apparatus 10 illustrated in FIG. 1 includes a main controller 15 and a plurality of probes 20. The main controller 15 can be connected to the plurality of probes 20 via an electrical line 25. The main controller 15 can be in two-way electrical connection with the probes 20. In this way, the main controller 15 can function as a central control panel for the apparatus 10. In some cases, the main controller 15 can include a non-transitory computer-readable storage article having computer-executable instructions stored thereon to cause at least one programmable processor thereof to execute one or more measurement sequences described herein. For instance, the main controller 15 may initiate a measurement sequence at a number of the probes 20, receive return signals from one or more probes 20, process return signals from one or more probes 20, store data, analyze data, and/or communicate and receive data over a network (e.g., a local network and/or an external, wide-area network). As one example, the main controller 15 can include measurement circuitry, a processor executing computer-executable instructions stored in a non-transitory computer readable medium, a user input facility (e.g., a touchscreen), a power source, and/or a transceiver (e.g., wireless cellular). In one embodiment, a power source for the main controller 15 is a solar panel mounted at the main controller 15. In this embodiment, the main controller 15 can further include a battery for storing collected solar energy as well as a controller for controlling battery charging. This may be useful in applications where the apparatus 10 is to be permanently installed adjacent a waste structure in a generally remote location.

In one embodiment, the probes 20 can be electrode probes. For instance, such electrode probes may be clad with stainless steel or copper. Each of the probes 20 extends a distance into a ground surface 30 (e.g., at a location spaced from and adjacent to a waste storage structure pond but not into the waste storage structure itself.). As one example, the probes 20 can be approximately one to four feet long and be buried underneath the ground surface 30 alongside one or more sides of the waste storage structure. The probes 20 are spaced from one another a distance D. The number of probes 20, as well as the spacing of the distance D between each of the probes 20, can vary as appropriate for the particular application of the subsurface monitoring apparatus 10. As examples, in one embodiment the main controller 15 is configured to support sixteen probes 20, in another embodiment the main controller 15 is configured to support thirty two probes 20, and in a further embodiment the main controller 15 is configured to support sixty four probes 20. In one embodiment, each of the probes 20 extends into the ground surface 30 the same distance and a spacing of the distance D between each adjacent probe 20 is generally uniform.

To monitor a subsurface condition, the subsurface monitoring apparatus 10 is configured to measure subsurface resistivity at the location spaced from and extending alongside one or more sides of the waste storage structure at various depths. For instance, by measuring soil subsurface resistivity using the subsurface monitoring apparatus 10 the presence of a leak emanating from the waste storage structure may be detected.

To obtain subsurface resistivity measurements, the main controller 15 can be configured to execute one or more measurement sequences using probes 20. One exemplary measurement sequence executed by the main controller 15 involves switching probes 20 between various combinations of drive probes and sense probes in generally successive scans. For instance, during a first scan in the measurement sequence, electrodes 20a and 20d can used as drive electrodes and controlled by the main controller 15 to pass an electric current (e.g., AC) into the ground surface 30. During this first scan, electrodes 20b and 20c are used as sense electrodes to pick up a voltage developed as the current from the drive electrodes 20a, 20d passes through the subsurface soil which acts as a resistor. As a result, the main controller 15 is able to measure a first resistance corresponding to a location longitudinally between the sense electrodes 20b, 20c and at a depth of approximately half the distance D between the sense electrodes 20b, 20c. During a second scan in the measurement sequence, the main controller 15 selects a new combination of drive and sense electrodes as appropriate to measure a second resistance corresponding to a different location, relative to the first scan, made up of a longitudinal span and depth that is a function of the selected drive and sense electrodes for that scan. By skipping an increasing number of electrode probes, resistivity measurements for greater depths can be obtained.

The main controller 15 can continue this measurement sequence by taking successive scans using select combinations of drive and sense probes 20. In this way, the apparatus 10 can obtain a set of subsurface resistivity measurements corresponding to a cross-sectional area (made up of the maximum longitudinal span and depth produced by the particular measurement sequence) below the ground surface 30 as appropriate for a specific application of the apparatus 10. In one example, the apparatus 10 is configured to take resistivity measurements for cross-sectional areas made up of subsurface depths up to fifty feet, one hundred feet, or three hundred feet and across longitudinal spans extending alongside one or more sides of a waste storage structure up to one hundred feet, two hundred feet, three hundred feet, one thousand feet, or more depending on the application. Thus, the apparatus 10 can be configured to take a large number of subsurface resistivity measurements (e.g., more than one hundred) as a function of the measurement sequence for use as the set of subsurface resistivity measurements corresponding to a cross-sectional subsurface area.

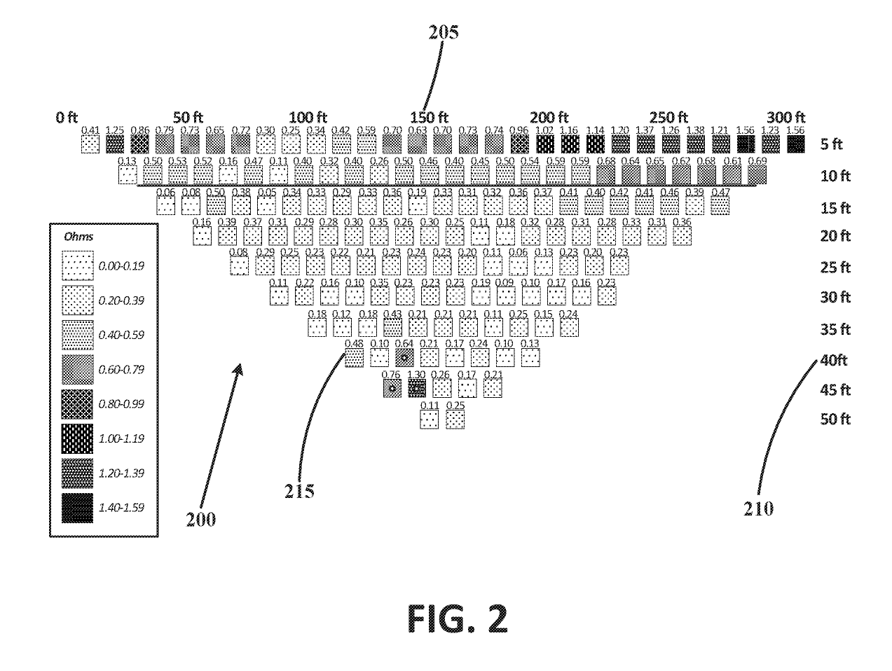

FIG. 2 shows an exemplary plot 200 of a set of subsurface resistivity measurements that can be obtained in a measurement sequence run by the subsurface monitoring apparatus 10 of FIG. 1. The set of subsurface resistivity measurements, making up the plot 200, can be the result of a particular measurement sequence executed by the main controller 15 during a first time according to the preceding disclosure.

As shown in the exemplary plot 200, the set of subsurface resistivity measurements corresponds to a subsurface area made up of a longitudinal span 205 and subsurface depth 210. The set of subsurface resistivity measurements, making up the plot 200, include a number of individual resistivity measurements 215. In the set of subsurface resistivity measurements there can be a number of individual resistivity measurements 215 each at different longitudinal spans 205 but at a same, first subsurface depth 210. Likewise, there can be a number of individual resistivity measurements 215 each at different longitudinal spans 206 but at a same, second greater subsurface depth 210. In certain cases, one or more individual subsurface resistivity measurements in a set of subsurface resistivity measurements can be an average, or other statistical combination, one two or more resistivity data points obtained in a particular measurement sequence during a first time. In some examples, the plot 200 can use a range visually distinctive indicators for the individual resistivity measurements 215 corresponding to a range of resistivity values so as to allow for the plot 200 to visually depict relative differences in the resistivity values of the set.

In some cases, the main controller 15 may be configured to run a measurement sequence for calibrating and/or testing operation of the apparatus 10. This could be referred to as a test measurement sequence. For example, one such embodiment of a test measurement sequence executed by the main controller 15 can include one or more scan sequences used to verify operation of the apparatus 10. One example includes switching calibrated resistors into a measuring circuit utilized by the main controller 15. The main controller 15 can then run a verification scan sequence (e.g., automatically) using the switched in, calibrated resistors in lieu of one or more drive and/or sense electrode probes and check to ensure that the resulting resistivity measurement aligns with an expected result based on the switched in, calibrated resistors. If the resistivity measurement aligns with the expected result, then the main controller 15 can determine that the apparatus 10 does not need calibrating or other maintenance action. For instance, the apparatus 10 can obtain a set of resistivity measurements corresponding to one or more test resistors switched into a measuring circuit of the main controller 15. This set of resistivity measurements can be compared to a predetermined resistivity associated with the one or more test resistors and a maintenance warning can be generated if the set of resistivity measurements differs from the predetermined resistivity by a predetermined maintenance threshold. The predetermined resistivity may, for example, correspond to a resistance measurement associated with a recognized resistance of subsurface earth terrain at the depths being monitored in the particular application (e.g., up to 50 feet).

A set of subsurface resistivity measurements associated with the same cross-sectional subsurface area (e.g. adjacent to the waste storage structure) can be obtained periodically and compared to a previous set (e.g., a set made up of a combination of previously obtained sets of subsurface resistivity measurements) to assess changes in subsurface resistance measurements at that area over time. For example, when the apparatus 10 is initially installed, an initial set, or sets, of subsurface resistivity measurements associated with the area can be obtained during a first time. A second, subsequent set of subsurface resistivity measurements associated with the area can be obtained during a second later time and compared to the initial set to assess changes in resistance across the area, such as at particular portions (e.g., specific longitudinal location(s) and depth(s)) of this area.

For example, a first set of subsurface resistivity measurements can be obtained in a measurement sequence run by the subsurface monitoring apparatus during a first time. This first set of subsurface resistivity measurements can be obtained, for instance, for a cross-sectional area such as that shown in the example of FIG. 2. A second set of subsurface resistivity measurements can be obtained in the same measurement sequence run by the subsurface monitoring apparatus during a second, later time. This second set of subsurface resistivity measurements can be obtained, for instance, for the same cross-sectional area as the first set of subsurface resistivity measurements (e.g., such as that cross-sectional area shown in the example of FIG. 2). Likewise, additional sets of subsurface resistivity measurements can be obtained in the same measurement sequence run by the subsurface monitoring apparatus during times after the second time.

Two or more sets of subsurface resistivity measurement can be compared to assess a subsurface condition. For example, the first and second, subsequent sets of subsurface resistivity measurements can be processed to compare one or more (e.g., all) corresponding individual resistivity measurements in each of the sets. An output based this comparison can be plotted for visualization on a user interface. This can allow for an assessment of a subsurface condition developing over a period of time between the times during which the sets of subsurface resistivity measurements were taken.

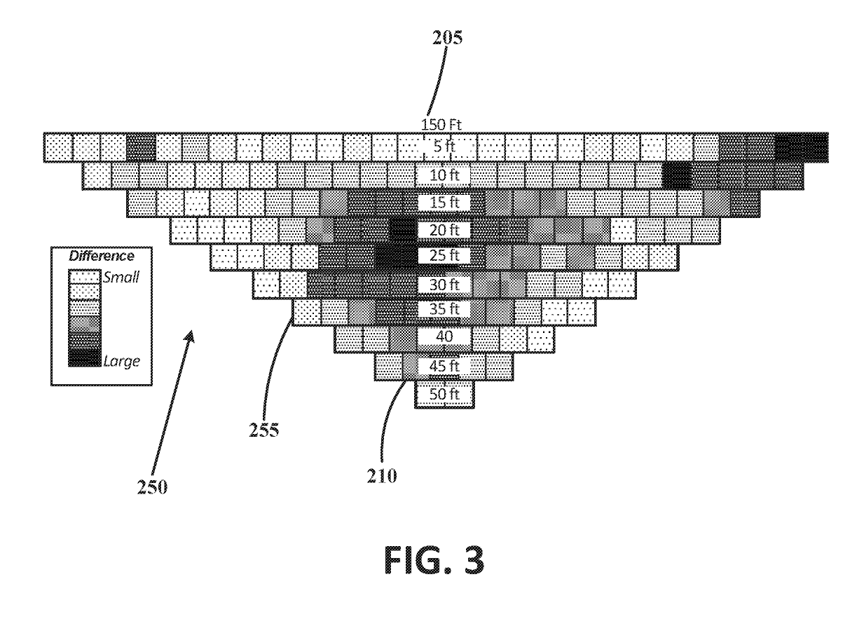

FIG. 3 is an exemplary graphical illustration of an analytical output 250 from a comparison between sets of subsurface resistivity measurements. In the example of FIG. 3, the comparison between sets of subsurface resistivity measurements indicates detection of a subsurface leak that is represented in graphical illustration.

The exemplary graphical illustration of the analytical output 250 shown in FIG. 3 represents the result of a comparison between the first set of subsurface resistivity measurements taken during a first time and shown in the example of FIG. 2 and a second set of subsurface resistivity measurements taken during a second, later time. These first and second sets represent the same cross-sectional area having the longitudinal span 205 (e.g., 300 feet here) and subsurface depth 210 (e.g., 50 feet here) as shown in the example of FIG. 3.

A recently obtained set of subsurface resistivity measurements (e.g., the second set) is compared to a baseline set of resistivity measurements (e.g., the first set) for the same area by determining a difference between one or more (e.g., all) corresponding individual resistivity measurements in the recently obtained set and the baseline set. This can include, for example, determining a difference in resistivity measurements between a resistance measurement at a first particular longitudinal location and depth in the baseline set and a resistance measurement at the corresponding first particular longitudinal location and depth in the recently obtained set. The output of the comparison between these the baseline resistivity measurement and the subsequent resistivity measurement can form a resistance measurement difference point 255 in the analytical output 250. Differences between other corresponding portions of the area can be compared across the sets to determine a number of resistance measurement difference points at various longitudinal span and depths between the recently obtained set and the baseline set for a corresponding number of locations in the area.

In one application, the greater the degree to which a recently obtained resistance measurement differs from a corresponding baseline resistance measurement, the greater the likelihood that a leak from an adjacent waste structure is present at that longitudinal span and depth location in the area. For instance, as can be seen in example of FIG. 3, relatively larger differences between corresponding measurement points in the sets of resistance measurements are present from approximately 100 feet to 200 feet longitudinally and 15 feet to 45 feet in depth, indicating the likely presence of a leak at this location. The graphical illustration of the analytical output 250 from the comparison can use a range visually distinctive indicators for each point of comparison among the sets corresponding to a range of differences in resistivity values for each point in the area so as to allow for the output 250 to visually depict relative differences between corresponding measurement points the sets.

A predetermined threshold for the resistivity difference can be used to determine whether the resistance measurement difference point 255 represents a notable data point. And then, depending on whether the sets of resistivity measurements have a certain number of resistance measurement difference points 255 where the predetermined threshold for the resistivity difference is exceeded, a notification (e.g., a leak notification) can be generated. The certain number of resistance measurement difference points 255 can be, for example, in one case an absolute number of individual measurement difference points 255 amongst the monitored area (e.g., one, two, five, ten, etc.) or in another case a percentage of the total number of individual measurement points making up the monitored area (e.g., 5%, 10%, 15%, 20%, 25%, etc.). In some cases, different predetermined thresholds can be used for different locations in the monitored area. For instance, for a certain depth and/or longitudinal location, a lower resistivity difference can be used as the predetermined threshold when assessing the resistance measurement different point 255 at that particular location while a greater resistivity difference can be used as the predetermined threshold when assessing the resistance measurement different point 255 at a different depth and/or longitudinal location. As detailed further below, in some embodiments the resistivity difference used as the predetermined threshold can be changed depending on other, non-resistance measurements received at the main controller.

In some embodiments, the baseline to which subsequent sets of subsurface resistivity measurements are compared can be an average of a number of resistivity measurement sets collected over a preceding time period for the area being monitored. Where the subsurface monitoring apparatus is a permanent installation, the baseline set of subsurface resistivity measurements may be an average of measurements corresponding to each of the various locations in the area over a period of weeks, months, or longer. The apparatus 10 can then collect a new corresponding set of subsurface resistivity measurements automatically at predetermined time intervals (e.g., hourly, daily, weekly, etc.) and run a comparison using the new set and the established baseline to assess whether a leak may be present using the extent to which corresponding resistance measurements for an area have changed over time.

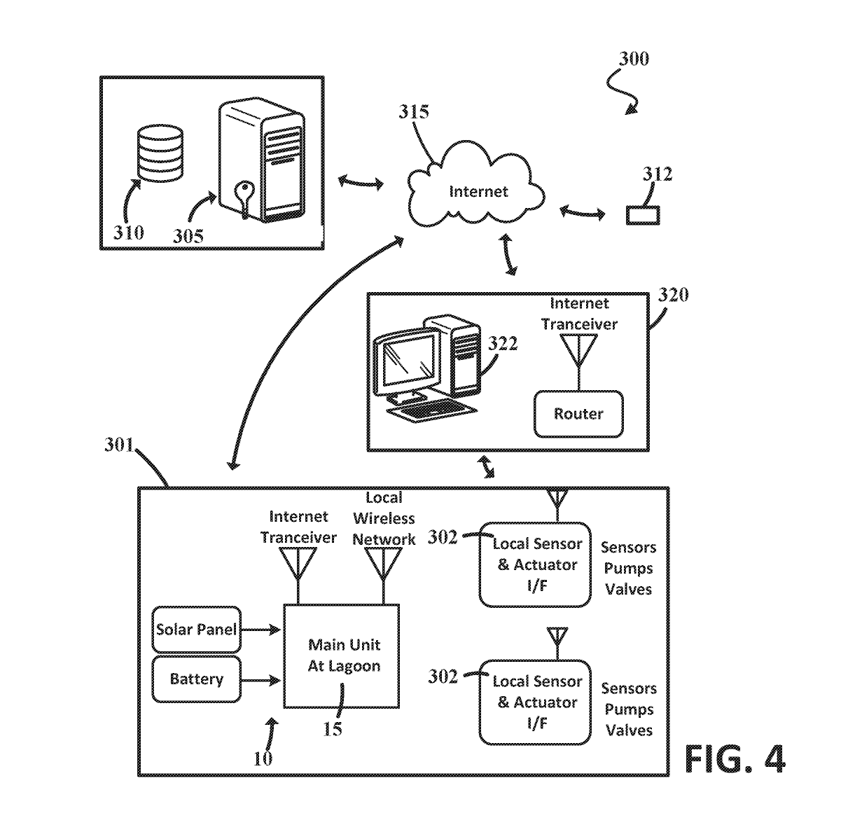

To increase functionality in some cases, the subsurface monitoring apparatus 10 can be included as part of an overall networked subsurface monitoring system. FIG. 4 illustrates a schematic diagram of an exemplary embodiment of a subsurface monitoring system 300, including the subsurface monitoring apparatus 10 as detailed previously with respect to FIG. 1.

As described previously, the subsurface monitoring apparatus 10 includes the main controller 15. The main controller 15 can include a gateway for local network capability at a customer site 301. The main controller 15 can be in two-way communication with one or more local devices 302 at the customer site 301 over a local network (e.g., wired or wireless), where the local devices 302 are at a location at the customer site 301 that is separate from the main controller 15. Such local devices 302 can include a variety of customer site sensors and process management devices, for instance resistivity sensor(s), weather station(s), soil moisture sensor(s), pump(s), valve(s), flowmeter(s), temperature sensor(s), rain gauge(s), etc. The main controller 15 can receive data from one or more of these local devices 302 as well as send control signals to one or more of these local devices 302. Over the local network, the main controller 15 can receive inputs from one or more of the local devices 302. Depending on the local devices, these inputs can include, for example, one or more of soil resistivity (e.g., at a location, which could be referred to as a calibration area, that is different than the location of the subsurface monitoring apparatus), soil moisture content, rainfall, water pressure, wind speed and/or direction, temperature, humidity, flow rate, fluid level, fluid volume, and solar radiation. The main controller 15 can also send control output signals to one or more of the local devices 302. Depending on the local devices, these control signals can, for example, include one or more of initiate resistivity measurement, pump on/off, valve open/close, and fan on/off.

The main controller 15 can collect data from one or more local devices 302 to help provide context in evaluating subsurface measurements obtained by the subsurface monitoring apparatus 10. In one exemplary embodiment, a local device 302 includes a fluid level sensor associated with a waste structure that the subsurface monitoring apparatus 10 is located adjacent to. The fluid level sensor is configured to measure a level of fluid within the waste structure and provide a signal related to the level of fluid within the waste structure to the main controller 15. Accordingly, in some cases, when the two or more sets of subsurface measurements, obtained at the subsurface monitoring apparatus 10, are compared, such as described previously, the fluid level within the waste structure can be used to provide context to the comparison of subsurface measurements, including in some cases altering the output based on the comparison when the fluid level within the waster structure is outside of a set operating range (e.g., greater than a predetermined amount indicating a potential overflow condition from the waste structure). For instance, if the fluid level in the waste structure overflows out from the waster structure (e.g., due to a heavy rain), the comparison of subsurface measurements may be altered to take into account the existence of overflow saturation into the ground surface around the waste structure. For instance, when the fluid level within the waster structure is greater than a predetermined amount, a predetermined threshold used for assessing an extent of difference between first and second sets of subsurface resistivity measurements may be increased for all of part of the cross-sectional area being monitoring so as to require a greater difference in the corresponding resistivity measurements of the first and second sets to generate a subsurface condition notification, such as a leak notification.

In another exemplary embodiment, to help provide context in evaluating subsurface measurements obtained by the subsurface monitoring apparatus 10, the main controller 15 can collect data from a local device 302 that includes a subsurface resistivity measurement device. As one specific example, this subsurface resistivity measurement device could be made up of one or more electrode probes similar to the apparatus 10. In this embodiment, the subsurface resistivity measurement device, as the local device 302, can be at a location that is different than the location of the subsurface monitoring apparatus 10. For instance, where the subsurface monitoring apparatus 10 is adjacent a waste structure, the subsurface resistivity measurement device, as the local device 302, can be at a location remote from the waste structure. In this way, the subsurface resistivity measurement device, as the local device 302, can measure subsurface resistivity at a calibration area that is different than the area adjacent to a waste structure that is measured by the subsurface monitoring apparatus 10.

In this exemplary embodiment, the main controller 15 can receive one or more resistance measurements (e.g., at different times) from the subsurface resistivity measurement device, as the local device 302, pertaining to the calibration area. Accordingly, in some cases, when the two or more sets of subsurface measurements, obtained at the subsurface monitoring apparatus 10, are compared, such as described previously, the resistance measurement(s) from the subsurface resistivity measurement device, as the local device 302, at the calibration area can be used to provide context to the comparison of subsurface measurements taken by the apparatus 10. This can be useful in accounting for changes in subsurface resistivity due to, for example, seasonal variations that can alter soil resistivity (e.g., temperature and/or precipitation). In one case, resistivity measurements from the local device 302 at different times at the calibration area can be used when comparing the two or more sets of subsurface measurements, obtained at the subsurface monitoring apparatus 10, so as to compensate for any changes in resistance values caused by one or more seasonal variations. For instance, when a difference between resistivity measurements from the local device 302 at different times at the calibration area is greater than a predetermined amount, this can be factored into assessing an extent of difference between first and second sets of subsurface resistivity measurements (e.g., taken at different times that each correspond to the times of those measurements at the calibration area) relative to a predetermined threshold. This could be done, for example, by increasing the predetermined threshold for all of part of the cross-sectional area being monitoring by the apparatus 10 so as to require a greater difference in the corresponding resistivity measurements of the first and second sets taken at the apparatus 10 to generate a subsurface condition notification, such as a leak notification. This could alternatively be done by normalizing the resistivity measurements of the first and second sets taken at the apparatus 10 to account for the difference between resistivity measurements from the local device 302 at different times (e.g., corresponding to the times of the first and second sets taken at the apparatus 10) at the calibration area being greater than a predetermined amount.

In some embodiments, one or more of the local devices may be located at the customer site 301 at a location that is out of range for direct communication over the local network with the main controller 15. In these embodiments, the main controller 15 and the local devices can be equipped with a mesh networking protocol. In this way, a first local device 302 out of direct range with the main controller 15 can hop an input signal through one or more other intermediate local devices 302 which act as repeaters to convey the input signal on to the main controller 15. Similarly, the main controller 15 can send a control signal to the first local device 302 out of direct range with the main controller 15 by hopping the control signal through one or more intermediate local devices 302 acting as repeaters for the control signal. In some embodiments, the main controller 15 can include logic that is executed to determine dynamically an optimal route to hop a control signal among the local devices 302. By providing mesh networking capability in the local network, costs associated with creating a connected network among local customer devices and the main controller 15 can be reduced since more expensive long-range transceivers may be avoided.

In addition to local network capability, the gateway allows for remote network capability at the main controller 15. The subsurface monitoring system 300 as shown in the illustrated example further includes a remote server 305 that can be in two-way communication with the main controller 15. In certain embodiments, multiple main controllers 15 at multiple different customer sites can be in communication with the remote server 305.

The remote server 305 can be associated with a remote database 310. The remote database 310 may include a variety of records. Records stored at the remote database 310 can include of a number of customer accounts as well as subsurface measurement data sets collected during one or more times by the subsurface monitoring apparatus at a particular customer site 301. The subsurface measurement data sets can be stored in the remote database 310 in association with a customer account corresponding to the customer site 301 from which the subsurface measurement data sets were obtained. The remote database 310, in some embodiments, can further store any other data collected at the particular customer site 301 in association with the customer account corresponding to the customer site 301 from which the data was collected.

In various embodiments, the remote server 305 can also be in communication (e.g., two-way) with a remote client device 312 over a network 315. For instance, the remote server 305 can serve a webpage to the remote client device 312 or send a variety of message types (e.g., email, text, etc.) to the remote client device 312. The remote server 305 can use such data conveyance mediums to provide data related to the customer site 301 to the remote client device 312. The remote database 310 can store records identifying remote client devices in association with a corresponding customer account thereat. The remote server 305, in some embodiments, can process data received from a main controller 15 and based on this processing determine whether to send a communication to a remote client device 312 associated with the corresponding customer site 301. The remote client device 312 can also request data from the remote server 305, whether initiated by the requesting remote client device 312 or in response to receiving data from the remote server 305. In addition, in some cases the remote client device 312 can send a control command to the remote server 305 which routes this control command on to the main controller 15. The main controller 15 can then take action according to the received control command. Such control commands can relate to the subsurface monitoring apparatus and/or other local devices on the local network.

In one embodiment, the system 300 can also include an office facility 320. When included, the office facility 320 may include an office computing device 322 that can be in communication with the main controller 15, remote server 305, and/or remote client device 312 over the network(s). In one particular example, the office facility be at the same customer site 301 as the main controller 15 and acts as a router for the main controller 15 to the remote server 305 and/or remote client device 312.

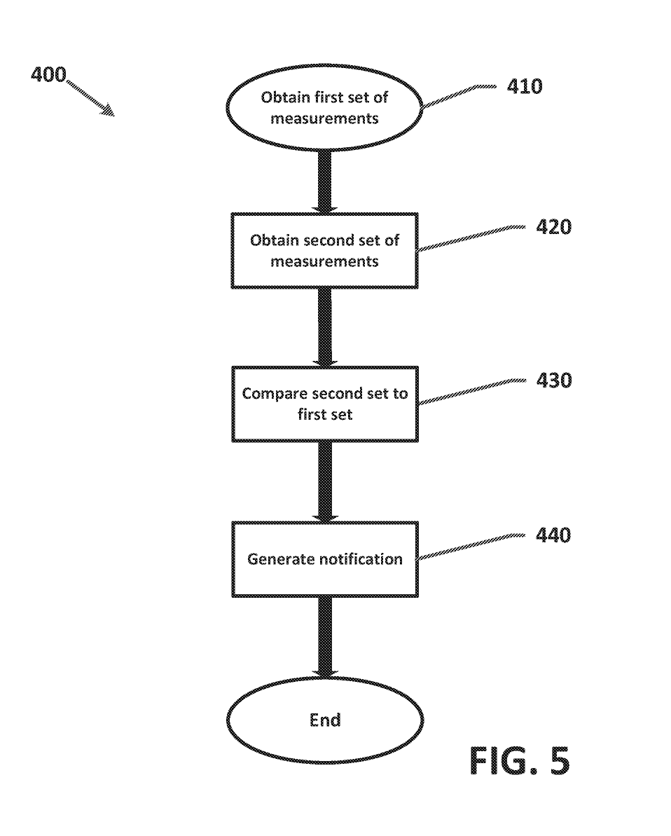

FIG. 5 illustrates a flow diagram of an exemplary embodiment of a method 400 for subsurface monitoring. At step 410, a first set of subsurface resistivity measurements is obtained during a first time using a subsurface monitoring apparatus. In some examples, the subsurface monitoring apparatus can be the same as or similar to that described herein. For many embodiments, obtaining the first set of subsurface resistivity measurements during the first time comprises obtaining multiple resistivity measurements including a first resistivity measurement at a first longitudinal location and a first depth and a second resistivity measurement at a second different longitudinal location and a second different depth. Obtaining the first set of subsurface resistivity measurements during the first time can further comprise taking additional subsurface resistivity measurements at various longitudinal location and depths as described herein. In some cases, the first set of subsurface resistivity measurements may be obtained at a time after installation of the subsurface monitoring apparatus. Moreover, in certain cases a number of sets of subsurface resistivity measurements may be obtained sequentially at times after installation and processed to establish a baseline mapping of resistivity measurements for an area within the subsurface area of interest (e.g., adjacent a waster structure).

At step 420, a second set of subsurface resistivity measurements are obtained during a second, subsequent time using the subsurface monitoring apparatus. For many embodiments, obtaining the second set of subsurface resistivity measurements during the second time comprises obtaining multiple resistivity measurements including the first resistivity measurement at the first longitudinal location and the first depth and the second resistivity measurement at the second different longitudinal location and a second different depth. Again, obtaining the second set of subsurface resistivity measurements during the second time can further comprise taking additional subsurface resistivity measurements at various longitudinal location and depths as described herein. In many instances, the locations at which the subsurface resistivity measurements in the second set are measured can be the same as the locations at which the subsurface resistivity measurements in the first set are measured (e.g., by executing the same measurement sequence during different times).

At step 430, the second set of subsurface resistivity measurements is compared to the first set of subsurface resistivity measurements. As one example, comparing the second set of subsurface resistivity measurements to the first set of subsurface resistivity measurements may include comparing the first resistivity measurement at the first longitudinal location and the first depth obtained during the second time to the first resistivity measurement at the same first longitudinal location and the same first depth obtained during the first time. It can further include comparing the second resistivity measurement at the second longitudinal location and the second depth obtained during the second time to the second resistivity measurement at the same second longitudinal location and the same second depth obtained during the first time. In some cases, step 430 can include comparing the second set of subsurface resistivity measurements to an aggregate (e.g., average) baseline of data for the subsurface area of interest that is composed of subsurface resistivity measurements obtained during the first time as well as during one or more other times between the first time and the second time. In one embodiment, the comparing step can further include comparing the second set of subsurface resistivity measurements to the first set of subsurface resistivity measurements in combination with evaluating a non-resistivity measurement obtained from a local device at the customer site at each of the first and second times. This may help to provide context in the evaluation as to differences in resistivity measurements across the first and second sets.

At step 440, a subsurface condition notification is generated when the second set of subsurface resistivity measurements differs from the first set of subsurface resistivity measurements by a first predetermined threshold. The subsurface condition notification could convey one or more of a variety of types of information depending on the application. For instance, the subsurface condition notification could be in the form of a leak notification indicating that the comparison among sets of subsurface resistivity measurements has detected that a waste structure could have an unintended fluid waste leak emanating therefrom. This first predetermined threshold can include a magnitude of resistivity difference between each corresponding individual resistivity measurements in the two sets. In certain instances, there can be different magnitudes of difference that constitute the first predetermined threshold depending on the longitudinal location and depth of the corresponding individual resistivity measurements in the two sets. As one example, generating the leak notification can include sending a first signal from the groundwater contamination measurement system to a remote server over a first network and sending a second signal from the remote server to a remote client device over a second network.

Although the present invention has been described with reference to certain disclosed embodiments, the disclosed embodiments are presented for purposes of illustration and not limitation and other embodiments of the invention are possible. A variety of related methods (e.g., methods of manufacturing, methods of installing, methods of using) are also within the scope of the present invention. One skilled in the art will appreciate that various changes, adaptations, and modifications may be made without departing from the spirit of the invention.

What is claimed is:

1. A subsurface monitoring system comprising:
a subsurface monitoring apparatus comprising:
a plurality of electrode probes spaced apart from one another and extending a distance into a ground surface, and
a main controller in electrical connection with each of the plurality of electrode probes, wherein the main controller is configured to:
execute a first measurement sequence during a first time to obtain a first set of subsurface resistivity measurements that includes individual subsurface resistivity measurements at a number of differing longitudinal and depth locations relative to the ground surface, and
execute the first measurement sequence during a second time that is after the first time to obtain a second set of subsurface resistivity measurements that includes individual subsurface resistivity measurement at the number of differing longitudinal and depth locations relative to the ground surface in the first set of subsurface resistivity measurements; and
a remote server in communication with the subsurface monitoring apparatus over a network,
wherein one of the subsurface monitoring apparatus and the remote server includes a non-transitory computer-readable storage article having computer-executable instructions stored thereon to cause at least one programmable processor to:
compare the second set of subsurface resistivity measurements to the first set of subsurface resistivity measurements, and
generate a subsurface condition notification when the second set of subsurface resistivity measurements differs from the first set of subsurface resistivity measurements by a first predetermined threshold.

2. The subsurface monitoring system of claim 1,
wherein the main controller is further configured to verify operation of the subsurface monitoring apparatus by executing a second measurement sequence comprising obtaining a third set of resistivity measurements corresponding to a number of test resistors switched into a measuring circuit of the subsurface monitoring apparatus, and
wherein the non-transitory computer-readable storage article having computer-executable instructions stored thereon causes the at least one programmable processor to:
compare the third set of resistivity measurements to a predetermined resistivity, and
generate a maintenance warning if the third set of subsurface resistivity measurements differs from the predetermined resistivity by a predetermined maintenance threshold.

3. The subsurface monitoring system of claim 2, wherein the predetermined resistivity corresponds to a resistance measurement associated with a recognized resistance of subsurface earth terrain at a range of depths being monitored by the subsurface monitoring apparatus.

4. The subsurface monitoring system of claim 1, wherein the remote server is configured to send the subsurface condition notification to a remote client device.

5. The subsurface monitoring system of claim 4, wherein the remote sever is associated with a database that contains account information for a first client site having the subsurface monitoring apparatus, and wherein the database includes a relational identifier for the remote client device based on the first client site having the subsurface monitoring apparatus at which the first set of subsurface resistivity measurements and the second set of subsurface resistivity measurements are obtained.

6. The subsurface monitoring system of claim 5, wherein the remote server stores a prior set of subsurface resistivity measurements obtained by subsurface monitoring apparatus at a time before the first time, and wherein the remote sever stores the prior set of subsurface resistivity measurements in association with the account information for the first client site.

7. The subsurface monitoring system of claim 1,
wherein the main controller is further configured to receive a non-resistivity measurement from a local device during the second time, and
wherein the non-transitory computer-readable storage article having computer-executable instructions stored thereon causes the at least one programmable processor to:
use the non-resistivity measurement obtained from the local device during the second time in comparing the second set of subsurface resistivity measurements to the first set of subsurface resistivity measurements.

8. The subsurface monitoring system of claim 7, wherein the non-resistivity measurement is used in comparing the second set of subsurface resistivity measurements to the first set of subsurface resistivity measurements to change the first predetermined threshold when the non-resistivity measurement is outside of a set operating range.

9. The subsurface monitoring system of claim 7, wherein the local device is a fluid level sensor associated with a waste structure that the subsurface monitoring apparatus is located adjacent to.

10. The subsurface monitoring system of claim 7, wherein the local device is a subsurface resistivity measurement device associated with a calibration area, wherein the subsurface monitoring apparatus is located adjacent to a waste structure, and wherein the calibration area is remote from the subsurface monitoring apparatus and the waste structure.

11. The subsurface monitoring system of claim 1, wherein the main controller is configured to execute the first measurement sequence during the first time to obtain the first set of subsurface resistivity measurements by obtaining multiple resistivity measurements including a first resistivity measurement at a first longitudinal location and a first depth during the first time and a second resistivity measurement at a second different longitudinal location and a second different depth during the first time.

12. The subsurface monitoring system of claim 11, wherein the main controller is configured to execute the first measurement sequence during the second time to obtain the second set of subsurface resistivity measurements by obtaining the multiple resistivity measurements including the first resistivity measurement at the first longitudinal location and the first depth during the second time and the second resistivity measurement at the second different longitudinal location and a second different depth during the second time.

13. The subsurface monitoring system of claim 12, the non-transitory computer-readable storage article having computer-executable instructions stored thereon causes the at least one programmable processor to compare the second set of subsurface resistivity measurements to the first set of subsurface resistivity measurements by:
i) comparing the first resistivity measurement at the first longitudinal location and the first depth during the second time to the first resistivity measurement at the first longitudinal location and the first depth during the first time, and
ii) comparing the second resistivity measurement at the second different longitudinal location and the second different depth during the second time to the second resistivity measurement at the second different longitudinal location and the second different depth during the first time.

14. The subsurface monitoring system of claim 1, wherein the main controller is configured to execute the first measurement sequence during the first time to obtain the first set of subsurface resistivity measurements by selectively switching amongst the plurality of electrode probes to form various combinations each having two designated sense electrode probes and two designated drive electrode probes, wherein the two designated sense electrode probes are disposed between the two designated drive electrode probes.

15. The subsurface monitoring system of claim 14, wherein the two designated drive electrode probes are configured to pass an electric current below the ground surface and the two designated sense electrode probes are configured to pick up a voltage developed as the electric current passed by the two designated drive electrode probes passes below the ground surface.

16. The subsurface monitoring system of claim 1, wherein the first predetermined threshold comprises a set proportion of a total number of individual subsurface resistivity measurement points that make up the first set of subsurface resistivity measurements that differ from corresponding individual subsurface resistivity measurement points that make up the second set of subsurface resistivity measurements by a preset resistivity amount.

17. The subsurface monitoring system of claim 1, wherein the first time comprises a first period of time and the first set of subsurface resistivity measurements comprises i) a first subset of subsurface resistivity measurements taken during the first period of time at different longitudinal locations and depths including a first longitudinal location and a first depth as well as a second longitudinal location and a second depth, and ii) a second subset of subsurface resistivity measurements taken during the first period of time, and after the first subset of subsurface resistivity measurements, at different longitudinal location and depths including the first longitudinal location and the first depth as well as the second longitudinal location and the second depth.

18. The subsurface monitoring system of claim 17, wherein the non-transitory computer-readable storage article having computer-executable instructions stored thereon causes the at least one programmable processor to compare the second set of subsurface resistivity measurements to the first set of subsurface resistivity measurements by comparing individual resistivity measurements in the second set of subsurface resistivity measurements to corresponding longitudinal location and depth individual resistivity measurements in the first set of subsurface resistivity measurements that comprise an average of corresponding resistivity measurements in the first subset of subsurface resistivity measurements and the second subset of subsurface resistivity measurements.

19. The subsurface monitoring system of claim 1, wherein the subsurface condition notification comprises a leak notification associated with a waste structure that the subsurface monitoring apparatus is located adjacent to.

20. A non-transitory computer-readable storage article having computer-executable instructions stored thereon to cause at least one programmable processor to:
receive a first set of subsurface resistivity measurements taken during a first time by a subsurface monitoring apparatus, the subsurface monitoring apparatus including a main controller electrically connected to a plurality of electrode probes, the plurality of electrode probes spaced apart from one another and extending a distance into a ground surface;
receive a second set of subsurface resistivity measurements taken during a second time by the subsurface monitoring apparatus, the second time being after the first time; compare the second set of subsurface resistivity measurements to the first set of subsurface resistivity measurements; and
output a leak notification when the second set of subsurface resistivity measurements differs from the first set of subsurface resistivity measurements by a first predetermined threshold.
